(19) United States
(12) Patent Application Publication
(10) Pub. No.: US 2013/0121721 A1
(43) Pub. Date: May 16, 2013

(54) DEVELOPER CONVEYANCE APPARATUS DEVELOPING APPARATUS AND PROCESS CARTRIDGE

(71) Applicant: CANON KABUSHIKI KAISHA, Tokyo (JP)

(72) Inventors: Tadashi Horikawa, Numazu-shi (JP); Satoshi Tsuda, Mishima-shi (JP)

(73) Assignee: CANON KABUSHIKI KAISHA, Tokyo (JP)

(21) Appl. No.: 13/673,080

(22) Filed: Nov. 9, 2012

(30) Foreign Application Priority Data
Nov. 15, 2011 (JP) 2011-249919

(51) Int. Cl. G03G 15/08

(52) U.S. Cl. 399/106

(57) ABSTRACT

A developer conveyance apparatus includes a developer storage portion storing developer, an opening for supplying developer from the developer storage portion, a sealing member configured to seal the opening, a removing member configured to remove the sealing member, and a conveyance portion arranged inside the developer storage portion and configured to convey the developer in a predetermined developer conveyance direction, wherein the conveyance portion can move between a first position and a second position on the upstream side with respect to the first position in the developer conveyance direction, and wherein when the conveyance portion receives a force not smaller than a predetermined magnitude from the developer with the conveyance portion rotating while the removing member is removing the sealing member from the opening, the conveyance portion moves from the first position to the second position.

### BACKGROUND OF THE INVENTION

1. Field of the Invention

The present disclosure relates to a developer conveyance apparatus, a developing apparatus, and a process cartridge for use in an image forming apparatus main body.

Here, the developer conveyance apparatus is an apparatus configured to convey developer used in an image forming apparatus. For example, it includes a process cartridge, a developer replenishment cartridge, a developer conveyance unit in an image forming apparatus, etc. The developing apparatus is an apparatus for use in an image forming apparatus, and serving to develop a latent image formed on an image bearing member. The process cartridge is equipped with an image bearing member, and is detachably attached to the apparatus main body of an image forming apparatus.

The image forming apparatus is configured to form an image on a recording medium. It includes an electrophotographic copying machine, an electrophotographic printer (light emitting diode (LED) printer, laser beam printer, etc.), an electrophotographic facsimile apparatus, etc., which are configured to form an image by using an electrophotographic process.

The recording medium is a substance on which an image is formed, and includes, for example, a recording sheet or an overhead projector (OHP) sheet.

2. Description of the Related Art

Conventionally, in an image forming apparatus, there has been adopted a process cartridge system in which an electrophotographic photosensitive member and a process unit acting thereon are integrated into a cartridge, which is detachably attached to the image forming apparatus main body. The process cartridge system, which allows the user to perform maintenance on the apparatus by himself or herself, helps to achieve an improvement in terms of operability.

The process cartridge is formed of a cleaning unit and a developing unit. The cleaning unit includes an electrophotographic photosensitive member, and a cleaning member for cleaning the surface of the electrophotographic photosensitive member. The developing unit includes a development roller supplying developer to an image bearing member, and a developer storage portion storing developer.

On the other hand, a developer replenishment system is known as an example of the process cartridge system. In this system, a developer replenishment opening of a developer replenishment cartridge and a developer receiving opening of a process cartridge are connected to each other, and developer is supplied from the developer replenishment cartridge to the process cartridge.

In the developer replenishment system, image defect is involved when new developer supplied from the developer replenishment cartridge is unevenly mixed with old developer in the developing unit. In view of this, Japanese Patent Application Laid-Open No. 2010-014890 discusses the following configuration for a developer replenishment type process cartridge.

The developing unit is divided into a developing portion and a developer storage portion. The developing portion and the developer storage portion are connected to each other by openings provided at both ends in the rotation axis direction (hereinafter referred to as the “longitudinal direction”) of the image bearing member. The developing portion and the developer storage portion are respectively provided with a developer conveyance member for conveying developer and a developer stirring member. The developer conveyance member and the developer stirring member convey developer in the longitudinal direction. In this way, developer is circulated within the developing unit, whereby new developer and old developer are uniformly mixed with each other.

However, in the system configuration as discussed in Japanese Patent Application Laid-Open No. 2010-014890, the developer in the developer storage portion may be compacted and coagulated. In particular, if during transportation, the process cartridge is caused to assume orientation in which its longitudinal direction coincides with the vertical direction and in which the downstream side in the conveyance direction of the developer conveyance member is at the bottom, coagulated developer is gathered on the downstream side in the developer conveyance direction in which the developer is conveyed by the developer conveyance member.

When, in this condition, the developer conveyance member is driven, the coagulated developer is further compacted by the developer conveyance member, so that the driving torque of the developer conveyance member increases.

As a countermeasure against this, Japanese Patent Application Laid-Open No. 11-160985 discusses a configuration in which a clutch is provided on a drive gear row of the developer stirring member and of the developer conveyance member. In the case in which the developer stirring member and the developer conveyance member are driven by the same drive source, when an excessive load is applied to the drive source, the rotation of the developer conveyance member is stopped to rotate the developer stirring member alone.

### SUMMARY OF THE INVENTION

The present disclosure is directed to suppressing an increase in driving torque at the time of use of the developer conveyance member by a simple configuration even when the developer in the developer storage portion is coagulated.

According to an aspect of the present disclosure, a developer conveyance apparatus for use in an image forming apparatus includes, a developer storage portion storing developer; an opening for supplying developer from an interior to an exterior of the developer storage portion, a sealing member configured to seal the opening, a removing member configured to remove the sealing member from the opening, and a conveyance portion arranged inside the developer storage portion and configured to convey the developer in a predetermined developer conveyance direction by rotating the conveyance portion, wherein the conveyance portion can move between a first position and a second position on the upstream side with respect to the first position in the developer conveyance direction, and wherein when the conveyance portion receives a force greater than or equal to a predetermined magnitude from the developer with the conveyance portion rotating while the removing member is removing the sealing member from the opening, the conveyance portion moves from the first position to the second position.

According to another aspect disclosed herein, a developing apparatus for use in an image forming apparatus include: a developer storage portion storing developer, an opening for supplying developer from an interior to an exterior of the developer storage portion, a developer bearing member configured to bear the developer supplied from the developer storage portion, a sealing member configured to seal the opening, a removing member configured to remove the sealing member from the opening; and a conveyance portion arranged inside the developer storage portion and configured to convey the developer in a predetermined developer conveyance direction by rotating the conveyance portion, wherein the conveyance portion can move between a first position and a second position on the upstream side with respect to the first position in the developer conveyance direction, and wherein when the conveyance portion receives a force greater than or equal to a predetermined magnitude from the developer with the conveyance portion rotating while the removing member is removing the sealing member from the opening, the conveyance portion moves from the first position to the second position.

According to yet another aspect of the present disclosure, a process cartridge detachably attached to an apparatus main body of an image forming apparatus includes an image bearing member, a developer storage portion storing developer, an opening for supplying developer from an interior to an exterior of the developer storage portion, a developer bearing member configured to bear the developer supplied from the developer storage portion, a sealing member configured to seal the opening, a removing member configured to remove the sealing member from the opening, and a conveyance portion arranged inside the developer storage portion and configured to convey the developer in a predetermined developer conveyance direction by rotating, wherein the conveyance portion can move between a first position and a second position on the upstream side with respect to the first position in the developer conveyance direction, and wherein when the conveyance portion receives a force greater than or equal to a predetermined magnitude from the developer with the conveyance portion rotating while the removing member is removing the sealing member from the opening, the conveyance portion moves from the first position to the second position.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the disclosure and, together with the description, serve to explain the principles of the invention.

FIG. 1 is a sectional view illustrating the configuration of a developer conveyance member according to an exemplary embodiment.

FIG. 2 is a schematic sectional view illustrating a color electrophotographic image forming apparatus according to an exemplary embodiment.

FIG. 3 is a main portion sectional view of a process cartridge and a developer replenishment cartridge according to an exemplary embodiment.

FIG. 4 is an overall perspective view of a process cartridge and a developer replenishment cartridge inside an image forming apparatus according to an exemplary embodiment.

FIG. 5 is an overall perspective view of a process cartridge according to an exemplary embodiment.

FIG. 6 is a perspective view illustrating the configuration of a developer replenishment cartridge according to an exemplary embodiment.

FIG. 7 is a sectional view illustrating the configuration of a developing unit according to an exemplary embodiment.

FIG. 8 is a perspective view illustrating how a sealing member and a take-up member according to an exemplary embodiment are connected together.

FIG. 9 is a perspective view illustrating how a developer conveyance member according to an exemplary embodiment is assembled.

FIG. 10 is a sectional view illustrating how a developer conveyance member according to an exemplary embodiment is driven in a state in which developer in a developer storage portion is coagulated.

### DESCRIPTION OF THE EMBODIMENTS

Various exemplary embodiments, features, and aspects of the disclosure will be described in detail below with reference to the drawings.

In the following, a color image forming apparatus using a process cartridge and a developer conveyance apparatus according to the present invention will be described with reference to the drawings.

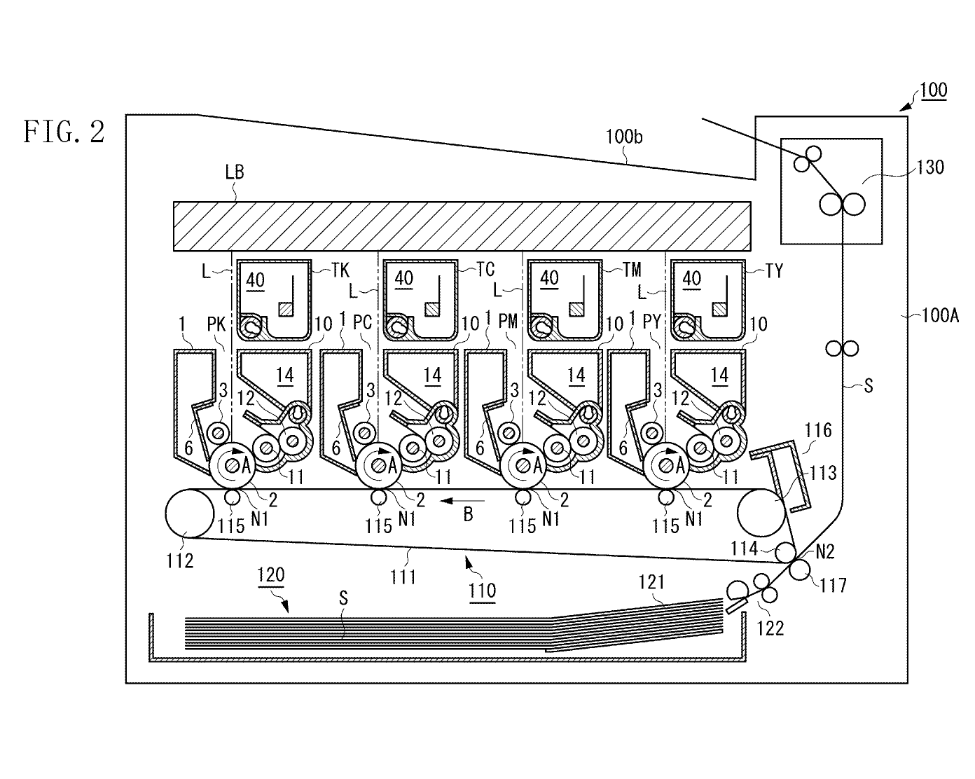

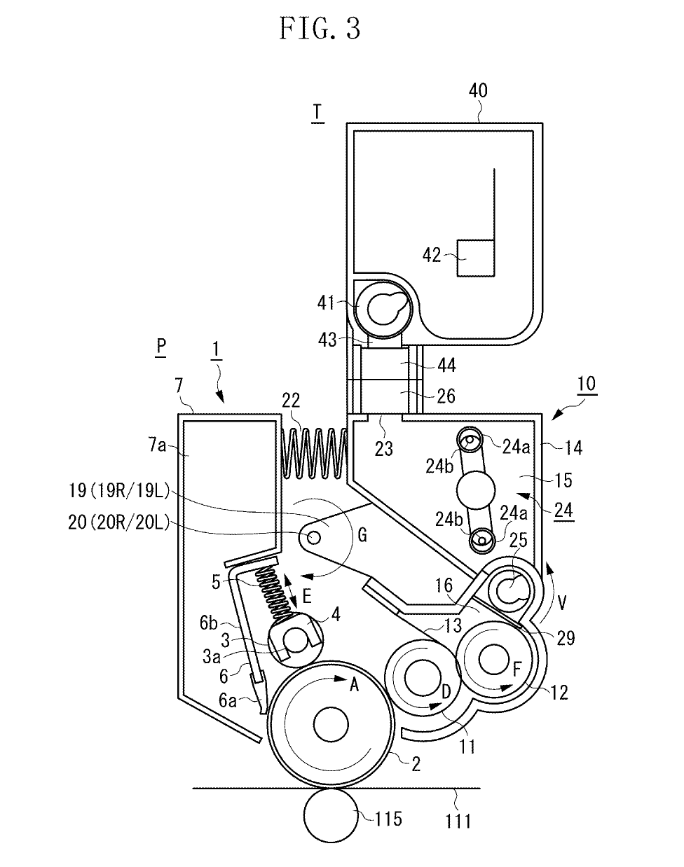

A first exemplary embodiment will be described. First, the overall configuration of the image forming apparatus will be described with reference to FIGS. 2 and 3. FIG. 2 is a schematic sectional view illustrating a color electrophotographic image forming apparatus. FIG. 3 is a main portion sectional view of a process cartridge and a developer replenishment cartridge.

An image forming apparatus 100 illustrated in FIG. 2 is a four-color full-color laser beam printer employing the electrophotographic image forming process, which performs color image formation on a recording medium S. The image forming apparatus 100 is of a process cartridge type. In this system, a process cartridge P and a developer replenishment cartridge T are detachably attached to an image forming apparatus main body 100A to form a color image on the recording medium S.

In the following description, the image forming apparatus main body (hereinafter referred to as the “apparatus main body”) 100A refers to the apparatus configuration portion which is the configuration of the image forming apparatus 100 excluding the process cartridge P and the developer replenishment cartridge T.

In the apparatus main body 100A, first through fourth process cartridges P (PY, PM, PC, and PK) and first through fourth developer replenishment cartridges T (TY, TM, TC, and TK) are arranged in the horizontal direction. Each of the process cartridges P and each of the developer replenishment cartridges T include a similar electrophotographic image forming process mechanism, and differ from each other in developer color and developer filling amount. A rotational driving force is transmitted to the process cartridges P and the developer replenishment cartridges T from the apparatus main body 100A. Further, a bias (charging bias, developing bias, etc.) is supplied to the process cartridges P from the apparatus main body 100A. The process cartridges P and the developer replenishment cartridges T are independently detachably attached to the apparatus main body 100A.

As illustrated in FIG. 3, each process cartridge P according to the present exemplary embodiment is formed by a cleaning unit 1 and a developing unit 10. The cleaning unit 1 is equipped with an electrophotographic photosensitive drum (hereinafter referred to as the “photosensitive drum”) 2 as an image bearing member, a charging roller 3 acting on the photosensitive drum 2, and a cleaning member 6. The developing unit 10 has a development unit for developing an electrostatic latent image on the photosensitive drum 2. The cleaning unit 1 and the developing unit 10 are swingably connected to each other.

The first process cartridge PY stores yellow (Y) developer inside a developer storage portion 15, and forms a yellow developer image on the photosensitive drum 2. Similarly, the second process cartridge PM stores magenta (M) developer, the third process cartridge PC stores cyan (C) developer, and the fourth process cartridge PK stores black (K) developer.

On the other hand, the first developer replenishment cartridge TY stores yellow (Y) developer inside a replenishment frame body 40, and supplies yellow developer to the process cartridge PY storing developer of the same color. Similarly, the second developer replenishment cartridge TM stores magenta (M) developer, and supplies magenta developer to the process cartridge PM storing developer of the same color. Similarly, the third developer replenishment cartridge TC stores cyan (C) developer, and supplies cyan developer to the process cartridge PC storing developer of the same color. Similarly, the fourth developer replenishment cartridge TK stores black (K) developer, and supplies black developer to the process cartridge PK storing developer of the same color.

As illustrated in FIG. 3, the replenishment frame body 40 of the developer replenishment cartridge T is provided with a developer replenishment opening 43 for supplying developer to the process cartridge P. The developer storage portion 15 of the process cartridge P is provided with a developer receiving opening 23 corresponding to the developer replenishment opening 43. When the process cartridge P and the developer replenishment cartridge T are attached to the apparatus main body 100A, the developer replenishment opening 43 and the developer receiving opening 23 communicate with each other, and developer is supplied from the developer replenishment cartridge T to the process cartridge P.

The process cartridge P and the developer replenishment cartridge T will be described in detail below.

As illustrated in FIG. 2, a laser scanner unit LB as an exposure unit is arranged above the process cartridges P (PY, PM, PC, and PK). The laser scanner unit LB outputs laser light L in correspondence with image information. Scanning exposure is performed on the surface of the photosensitive drum 2 with the laser light L.

An intermediate transfer belt unit 110 as a primary transfer member is arranged under the process cartridges P (PY, PM, PC, and PK). The intermediate transfer belt unit 110 has an endless transfer belt 111 exhibiting flexibility, and a driving roller 112, a driven roller 113, and a secondary transfer counter roller 114, between which the transfer belt 111 is stretched and rotated. The photosensitive drums 2 of each of the process cartridges Pare in contact with the transfer belt 111. Contact portions N1 between the photosensitive drums 2 and the transfer belt 111 are primary transfer portions. On the inner side of the transfer belt 111, there are arranged primary transfer rollers 115 so as to be opposite to the photosensitive drums 2. A secondary transfer roller 117 as a secondary transfer member is arranged at a position opposite to the secondary transfer counter roller 114. A contact portion N2 between the transfer belt 111 and the secondary transfer roller 117 is a secondary transfer portion.

A feeding unit 120 is arranged under the intermediate transfer belt unit 110. The feeding unit 120 is a recording medium conveyance unit conveying the recording medium S, and includes a feeding tray 121 accommodating the recording medium S, and a feed-out roller 122. A fixing unit 130 is arranged in the upper portion of the interior of the apparatus main body 100A. The upper surface of the apparatus main body 100A constitutes a discharge tray 100b.

Next, a full-color image forming operation will be described with reference to FIG. 2. FIG. 2 is a schematic sectional view of the color electrophotographic image forming apparatus.

The full-color image forming operation is as follows: The first through fourth process cartridges P (PY, PM, PC, and PK) are driven in the direction of the arrow A of FIG. 2 at a predetermined speed. The transfer belt 111 is rotated in the direction of the arrow B (the forward direction with respect to the rotation of the photosensitive drums). At this time, the speed of the transfer belt 111 corresponds to the speed of the photosensitive drums 2. At the same time, the laser scanner unit LB is driven.

In synchronization with the driving of the laser scanner unit LB, the charging rollers 3 of the process cartridges P uniformly charge the surfaces of the photosensitive drums 2 to a predetermined polarity and potential. The laser scanner unit LB performs scanning exposure on the surfaces of each of the photosensitive drums 2 with laser light L corresponding to image signals of each of the different colors. As a result, electrostatic latent images in conformity with the image signals of the corresponding colors are formed on the surfaces of the photosensitive drums 2. The electrostatic latent images formed are developed by the development rollers 11.

The development rollers 11 are developer bearing members. They bear the developers for developing the latent images formed on the photosensitive drums as the image bearing members.

Through the above image forming operation, a yellow developer image is formed on the photosensitive drum 2 of the first process cartridge PY. And, the yellow developer image is primarily transferred onto the transfer belt 111. Similarly, the developer images of the second process cartridge PM, the third process cartridge PC, and the fourth process cartridge PK are superimposed one upon the other on the transfer belt 111 to form an unfixed full-color developer image in four colors.

On the other hand, the recording medium S stored in the feeding tray 121 is fed with a predetermined control timing. The full-color developer image in four colors on the transfer belt 111 is collectively transferred onto the surface of the recording medium S introduced into the secondary transfer portion N2.

The recording medium S is separated from the surface of the transfer belt 111, and is introduced into the fixing unit 130. Then, the recording medium is heated and pressurized at a fixing nip portion. As a result, the developer image is fixed to the recording medium S. After this, the recording medium S that has undergone fixing is conveyed to the discharge tray 100b, whereby the full-color image forming operation is completed.

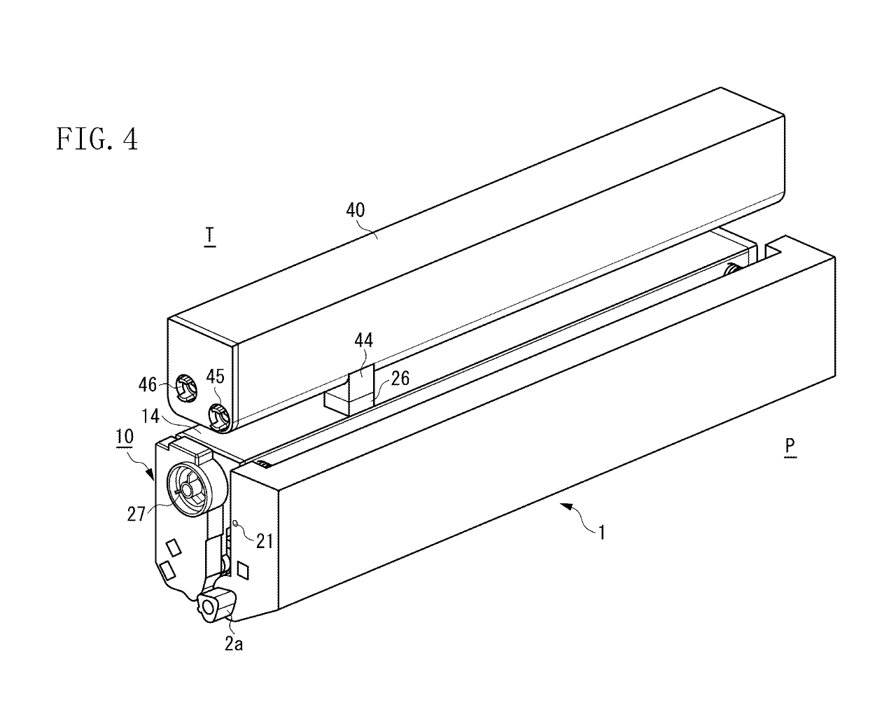

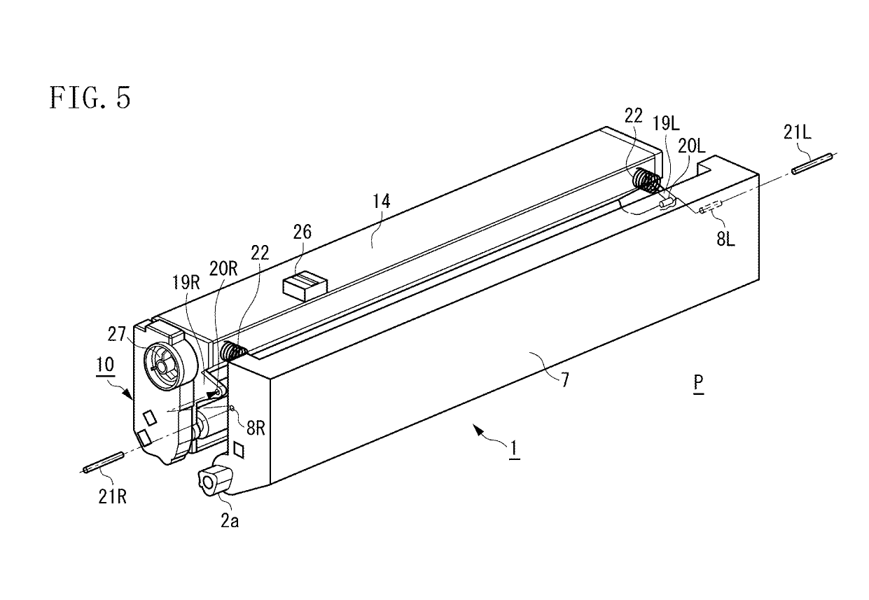

Next, the overall configuration of the process cartridge will be described with reference to FIGS. 3, 4, and 5. FIG. 3 is a main portion sectional view of the process cartridge and the developer replenishment cartridge. FIG. 4 is an overall perspective view of the process cartridge and the developer replenishment cartridge within the image forming apparatus. FIG. 5 is an overall perspective view of the process cartridge.

As illustrated in FIG. 3, the process cartridge P (PY, PM, PC, and PK) is formed by the cleaning unit 1 and the developing unit 10.

First, the cleaning unit 1 will be described. The cleaning unit 1 includes, inside the cleaning frame body 7, the photosensitive drum 2, the charging roller 3, and the cleaning member 6.

The photosensitive drum 2 is rotatably supported by the cleaning frame body 7. As illustrated in FIG. 4, a drum drive coupling 2a is provided at one end of the photosensitive drum 2. The photosensitive drum 2 and the drum drive coupling 2a are formed integrally. The drum drive coupling 2a is engaged with a coupling (not illustrated) of the apparatus main body 100A. The driving force of a driving motor (not illustrated) of the apparatus main body 100A is transmitted to the drum drive coupling 2a, whereby the photosensitive drum 2 is rotationally driven in the direction of the arrow A at a predetermined speed.

The charging roller 3 is rotatably driven while being in contact with the photosensitive drum 2. As illustrated in FIG. 3, the charging roller 3 is mounted to the cleaning frame body 7 via a charging roller bearing 4. The charging roller 3 is mounted so as to be movable in the direction of the arrow E along the line connecting the rotation center of the charging roller 3 and the rotation center of the photosensitive drum 2. A rotation shaft 3a of the charging roller 3 is rotatably supported by the charging roller bearing 4. The charging roller bearing 4 is urged toward the photosensitive drum 2 by a charging roller pressurization member 5.

The cleaning member 6 is formed by an elastic rubber blade 6a at the distal end thereof and a support metal plate 6b. The distal end of the elastic rubber blade 6a is held in contact with the photosensitive drum 2 in a counter direction with respect to the rotational direction of the photosensitive drum 2 (the direction of the arrow A in FIG. 3). The cleaning member 6 removes the remaining developer on the photosensitive drum 2. The developer removed from the peripheral surface of the photosensitive drum 2 by the cleaning member 6 is accommodated in a removed developer storage portion 7a of the cleaning frame body 7.

Next, the developing unit 10 will be described. As illustrated in FIG. 3, the developing unit 10 includes a development frame body 14 supporting the various elements in the developing unit 10. The development frame body 14 is divided into a development portion 16 and a developer storage portion 15.

Provided in the development portion 16 are the development roller 11, a developer supply roller (hereinafter referred to as the “supply roller”) 12, and a development blade 13. The development roller 11 rotates in the direction of the arrow D while being in contact with the photosensitive drum 2. The supply roller 12 rotates in the direction of the arrow F while being in contact with the development roller 11. The supply roller 12 has two functions: First, it supplies developer onto the development roller 11; second, it scrapes off the developer remaining on the development roller 11 without having been used for development. The development blade 13 is held in contact with the peripheral surface of the development roller 11, thereby regulating the thickness of the developer layer on the development roller 11.

On the other hand, the developer storage portion 15 stores the developer supplied from the developer replenishment cartridge T. The developer storage portion 15 will be described in detail below.

Next, the connection between the cleaning unit 1 and the developing unit 10 will be described. As illustrated in FIG. 5, the cleaning frame body 7 includes cleaning connection holes 8 (8R and 8L). As illustrated in FIGS. 3 and 5, at both longitudinal ends of the development frame body 14, there are provided development side plates 19 (19R and 19L). The development side plates 19 (19R and 19L) include development connection holes 20 (20R and 20L). As illustrated in FIG. 5, the cleaning connection holes 8 (8R and 8L) and the development connection holes 20 (20R and 20L) are fit-engaged with connection shafts 21 (21R and 21L), whereby swingable connection is effected. As a result, the cleaning unit 1 and the developing unit 10 are connected to each other.

As illustrated in FIGS. 3 and 5, pressure springs 22 are arranged between the cleaning unit 1 and the developing unit 10. Owing to the urging force of the pressure springs 22, the developing unit 10 obtains a rotational moment in the direction of the arrow G around the development connection holes 20 as a center. As a result, the development roller 11 is held in contact with the photosensitive drum 2.

Although in the present exemplary embodiment the development roller 11 is arranged so as to be in contact with the photosensitive drum 2, it may also be arranged at a predetermined distance from the photosensitive drum 2.

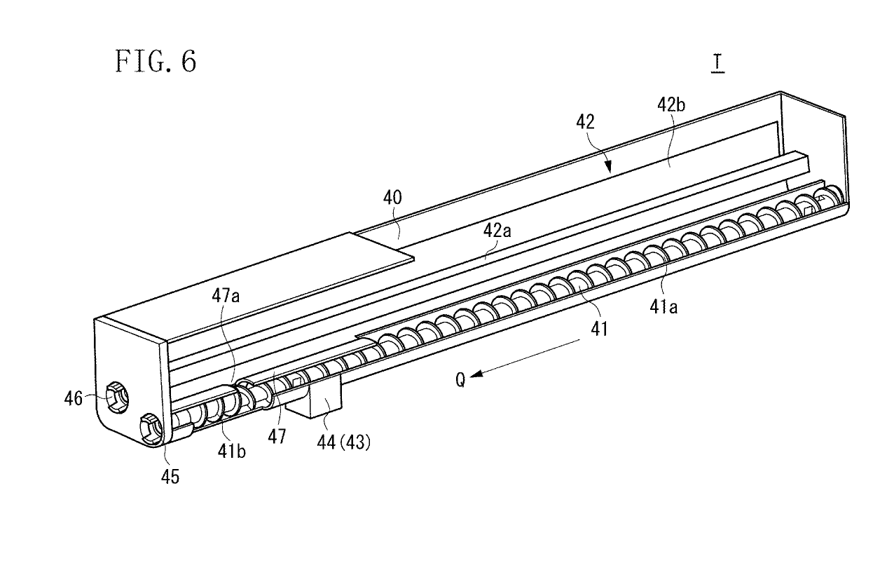

Next, the configuration of the developer replenishment cartridge will be described with reference to FIGS. 3 and 6. FIG. 3 is a main portion sectional view of the process cartridge and the developer replenishment cartridge. FIG. 6 is a perspective view illustrating the configuration of the developer replenishment cartridge.

As illustrated in FIG. 3, the developer replenishment cartridge T includes a replenishment frame body 40 for storing developer. The replenishment frame body 40 includes a developer replenishment opening 43 for supplying developer to the process cartridge P. A developer replenishment shutter 44 is provided under the developer replenishment opening 43. Normally, the developer replenishment shutter 44 is closed. It is configured to be opened in the state in which the process cartridge P and the developer replenishment cartridge T have been attached to the apparatus main body 100A.

Provided in the replenishment frame body 40 are a replenishment conveyance member 41 and a replenishment stirring member 42. The replenishment conveyance member 41 and the replenishment stirring member 42 are rotatably supported by the replenishment frame body 40. The replenishment conveyance member 41 conveys the developer in the replenishment frame body 40 toward the developer replenishment opening 43. As illustrated in FIG. 6, the replenishment conveyance member 41 is a screw member including on its surface a spiral fin 41a and a return fin 41b. The fin 41a conveys the developer in the direction of the arrow Q. The return fin 41b conveys the developer in the direction reverse to that of the fin 41a. A cover member 47 is provided above the replenishment conveyance member 41. The cover member 47 covers the developer replenishment opening 43 and a part in the longitudinal direction of the replenishment conveyance member 41. The cover member 47 is provided with a return hole 47a.

On the other hand, the replenishment stirring member 42 includes two functions: First, it stirs the developer in the replenishment frame body 40; second, it sends the stirred developer to the replenishment conveyance member 41. The replenishment stirring member 42 is formed by a replenishment stirring portion 42a and a replenishment stirring sheet 42b.

At one longitudinal end of the replenishment conveyance member 41 and the replenishment stirring member 42, there are respectively provided a replenishment conveyance coupling 45 and a replenishment stirring coupling 46. The replenishment conveyance coupling 45 and the replenishment stirring coupling 46 are engaged with a coupling (not illustrated) of the apparatus main body 100A. The driving force of the driving motor (not illustrated) of the apparatus main body 100A is transmitted to the replenishment conveyance coupling 45 and the replenishment stirring coupling 46, whereby the replenishment conveyance member 41 and the replenishment stirring member 42 are rotated at a predetermined speed.

The conveyance of the developer in the developer replenishment cartridge T will be described. The developer in the replenishment frame body 40 is stirred by the replenishment stirring member 42, and is sent to the replenishment conveyance member 41. When conveyed to the cover member 47, the developer sent to the replenishment conveyance member 41 is partially regulated by the cover member 47. As a result, the amount of developer discharged from the developer replenishment opening 43 is constant. The developer conveyed into the cover member 47 is discharged to the process cartridge P via the developer replenishment opening 43. The developer that has not been discharged from the developer replenishment opening 43 is sent to the replenishment stirring member 42 via the return hole 47a by the return fin 41b to be stirred again.

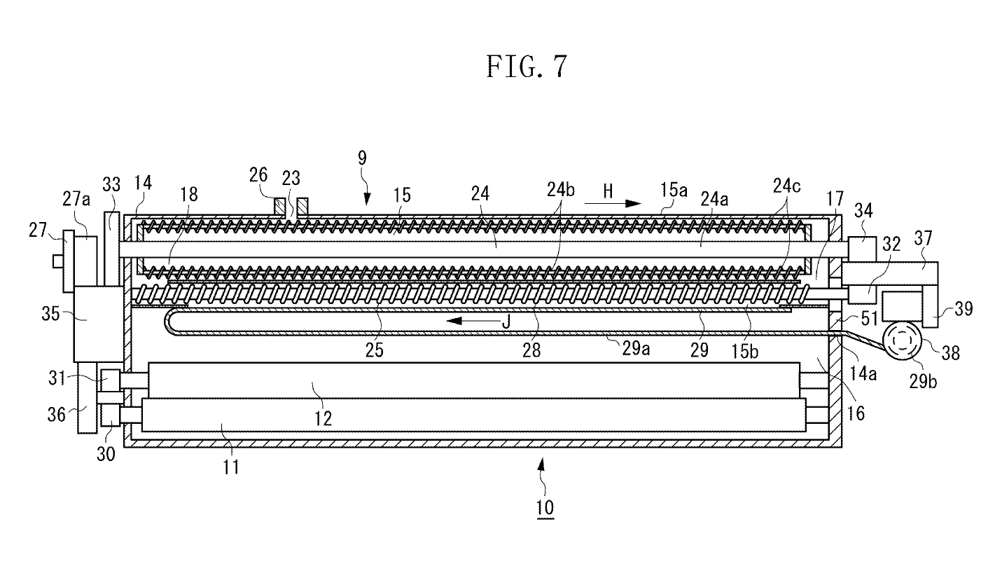

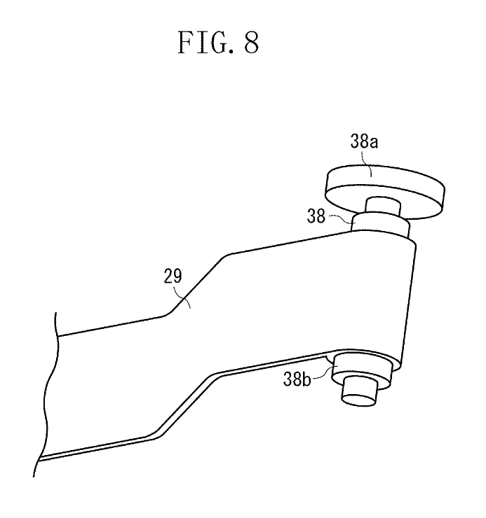

Next, the configuration of a developer conveyance unit (developer conveyance apparatus) 9 used in the image forming apparatus 100 will be described with reference to FIGS. 7 and 8. FIG. 7 is a sectional view illustrating the configuration of the developing unit. FIG. 8 is a perspective view illustrating how a sealing member and a take-up member are connected.

In the present exemplary embodiment, the developer conveyance unit (developer conveyance apparatus) 9 is formed by the developer storage portion 15 provided in the developing unit 10, and members such as a developer conveyance member 25 mounted to the developer storage portion 15. In the present exemplary embodiment, the developer conveyance apparatus 9 conveys developer from the developer storage portion 15 toward the development roller 11.

As illustrated in FIG. 7, the developer storage portion 15 is divided into a first storage portion 15a and a second storage portion 15b. The first storage portion 15a and the second storage portion 15b are connected to each other by a first opening 17 and a second opening 18 provided at both longitudinal ends.

The first storage portion 15a is provided with a developer receiving opening 23. A developer receiving shutter 26 is arranged above the developer receiving opening 23. Normally, the developer receiving shutter 26 is closed. It is configured to be opened when the process cartridge P and the developer replenishment cartridge T have been attached to the apparatus main body 100A.

The second storage portion 15b is connected to the development portion 16 via a development opening 28. When the process cartridge P has not been used yet, the development opening 28 is sealed by a sealing member 29. Here, the development opening 28 is an opening for discharging developer from the developer storage portion 15 and supplying it to the development portion 16.

The sealing member 29 prevents leakage of developer from the developer storage portion 15 during the transportation of the process cartridge P. The sealing member 29 is bonded to the surface of the development opening 28 by welding or the like. One end in the longitudinal direction of the sealing member 29 is folded back, and extends to the exterior of the development frame body 14 past a seal opening 14a provided in the development frame body 14.

The seal opening 14a is provided with a seal member 51. The seal member 51 prevents leakage of developer from the seal opening 14a. A longitudinal end portion 29b of the folded-back portion 29a of the sealing member 29 is connected with a take-up member 38 outside the development frame body 14. As illustrated in FIG. 8, the take-up member 38 includes a take-up gear portion 38a and a take-up shaft portion 38b. The sealing member 29 is bonded to the take-up shaft portion 38b by a double-sided tape or the like. When using the process cartridge P, the sealing member 29 is removed by being taken up by the take-up member 38. In other words, the take-up member 38 is a removing member for removing the sealing member 29 from the development opening 28. The removal of the sealing member 29 by the take-up member 38 will be described in detail below.

The first storage portion 15a is provided with a developer stirring member 24. The developer stirring member 24 has two functions: First, it mixes the developer in the developer storage portion 15 with the developer supplied from the developer replenishment cartridge T; second, it conveys the developer mixture in the direction of the arrow H. The developer stirring member 24 includes a development stirring shaft 24a, around which is provided a development support shaft 24b, to which a stirring spring 24c is mounted. On the other hand, a developer conveyance member 25 is provided inside the second storage portion 15b. The developer conveyance member 25 is a screw member configured to convey developer in the direction of the arrow J. The developer conveyance member 25 will be described in detail below.

The conveyance of developer in the developing unit 10 will be described. The developer supplied from the developer replenishment cartridge T is mixed with the developer in the developer storage portion 15 within the first storage portion 15a by the developer stirring member 24. The resultant developer mixture is sent to the second storage portion 15b past the first opening 17. In the second storage portion 15b, the developer is conveyed from the development opening 28 to the development portion 16 by the developer conveyance member 25. The developer conveyed to the development portion 16 is sent to the development roller 11 to be borne by the development roller 11. The developer borne by the development roller 11 develops an electrostatic latent image formed on the photosensitive drum 2 (See FIG. 3). The developer that has not been used for development returns to the second storage portion 15b from the development portion 16. After this, it is conveyed from the second opening 18 to the first storage portion 15a by the developer conveyance member 25.

Next, the drive system for the developing unit 10 will be described with reference to FIGS. 5 and 7. FIG. 5 is an overall perspective view of the process cartridge P. FIG. 7 is a sectional view of the configuration of the developing unit 10.

As illustrated in FIG. 7, a development roller driving gear 30 for transmitting drive to the development roller 11 is provided at one end of the development roller 11. A supply roller driving gear 31 for transmitting drive to the supply roller 12 is provided at one end of the supply roller 12. A development conveyance gear 32 for transmitting drive to the developer conveyance member 25 is provided at one end of the developer conveyance member 25. A first development stirring gear 33 for transmitting drive to the developer stirring member 24 is provided at one end of the developer stirring member 24. A second development stirring gear 34 for transmitting drive from the developer stirring member 24 is provided at the other end of the developer stirring member 24.

On the other hand, as illustrated in FIG. 5, a development drive coupling 27 is provided at one longitudinal end of the developing unit 10. The development drive coupling 27 is engaged with a coupling (not illustrated) of the apparatus main body 100A. When the driving force of the driving motor (not illustrated) of the apparatus main body 100A is transmitted to it, the development drive coupling 27 rotates at a predetermined speed.

The driving force of the apparatus main body 100A is transmitted from the development drive coupling 27 by the following route:

As illustrated in FIG. 7, the drive of the development drive coupling 27 is transmitted from a gear portion 27a of the development drive coupling 27 to the development roller driving gear 30 and the supply roller driving gear 31 via a first idler gear 35 and a second idler gear 36. As a result, the development roller 11 and the supply roller 12 are rotationally driven.

The drive of the first idler gear 35 is also transmitted to the first development stirring gear 33, thereby driving the developer stirring member 24. The drive of the developer stirring member 24 is transmitted to the developer conveyance gear 32 from the second development stirring gear 34 via a third idler gear 37, thereby rotationally driving the developer conveyance member 25.

Further, the drive of the third idler gear 37 is also transmitted to a fourth idler gear 39. The drive of the fourth idler gear 39 is transmitted to the take-up gear portion 38a of the take-up member 38, thereby rotating the take-up member 38. As a result, the sealing member 29 is taken up, and is removed from the development opening 28.

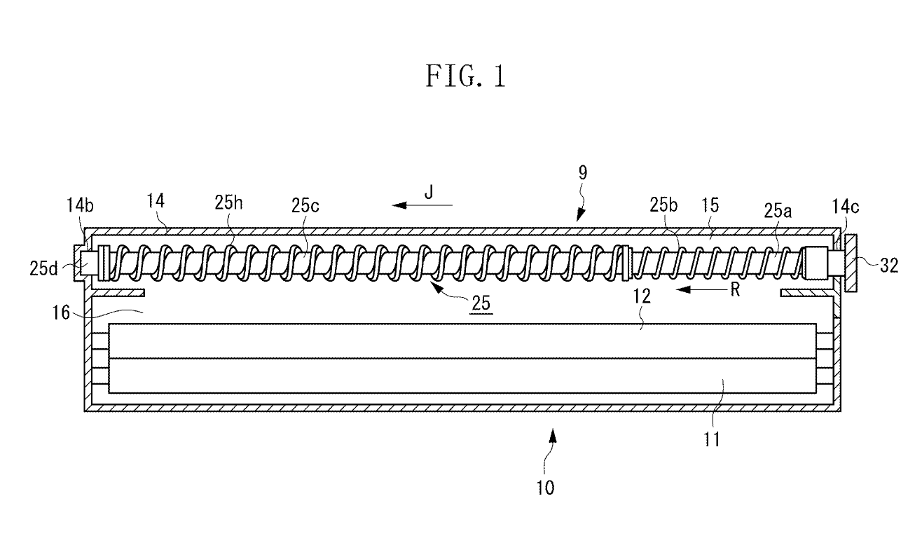

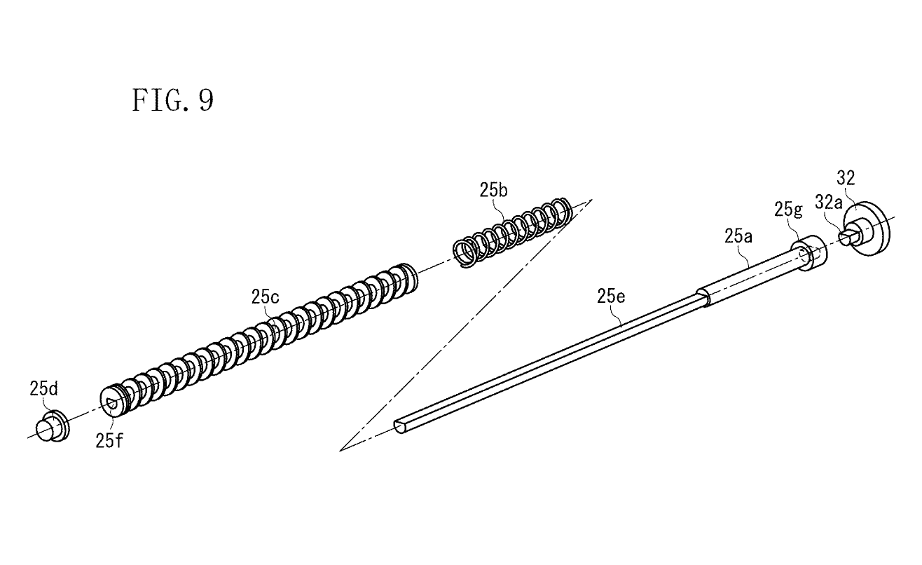

Next, the configuration of the developer conveyance member 25 provided in the developer conveyance apparatus 9 will be described with reference to FIGS. 1, 3, and 9. FIG. 1 is a sectional view illustrating the configuration of the developer conveyance member. FIG. 3 is a main portion sectional view of the process cartridge and the developer replenishment cartridge. FIG. 9 is a perspective view illustrating how the developer conveyance member is assembled.

As illustrated in FIG. 1, the developer conveyance member 25 is formed by a support shaft 25a, an urging member 25b, a conveyance portion 25c, and a cap member 25d.

The support shaft 25a is a shaft supporting the urging member 25b and the conveyance portion 25c. The conveyance portion 25c constitutes a screw, which is configured to convey developer in a predetermined developer conveyance direction J through rotation.

As illustrated in FIG. 9, the connection of the support 25a and the conveyance portion 25c is effected through fit-engagement of a first D-cut shaft portion 25e of the support shaft 25a and a first D-cut hole portion 26f of the conveyance portion 25c.

The first D-cut shaft portion 25e and the first D-cut hole portion 25f are both of a D-shaped sectional configuration. As a result, when the first D-cut shaft portion 25e and the first D-cut hole portion 25f are fit-engaged with each other, the support shaft 25a and the conveyance portion 25c can rotate integrally.

As illustrated in FIG. 1, one longitudinal end of the support shaft 25a is connected to the development conveyance gear 32, and the cap member 25d is attached to the other end thereof. As illustrated in FIG. 9, the connection between the support shaft 25a and the development conveyance gear 32 is effected through fit-engagement of the second D-cut shaft 32a of the development conveyance gear 32 with the second D-cut hole portion 25g of the support shaft 25a.

The second D-cut shaft portion 32a and the second D-cut hole portion 25g are of a D-shaped sectional configuration, so that when the second D-cut shaft 32a is fit-engaged with the second D-cut hole portion 25g, the development conveyance gear 32 and the support shaft 25a can rotate integrally.

The urging member 25b is a torsion coil spring. As illustrated in FIG. 1, it urges the conveyance portion 25c in the direction of the arrow R. Further, like the conveyance portion 25c, the urging member 25b has a function to convey developer in the direction of the arrow J in FIG. 1. Thus, when the developer conveyance member 25 drives, the urging member 25b rotates in the direction of the arrow V in FIG. 3 together with the conveyance portion 25c, and conveys developer in the developer conveyance direction J (See FIG. 1).

To convey developer as described above, the present exemplary embodiment employs a left-handed torsion coil spring as the urging member 25b. Specifically, as seen from the upstream side in the developer conveyance direction J, the torsion coil spring (urging member 25) is wound in the direction reverse to the rotational direction of the conveyance portion 25c from the upstream side toward the downstream side in the developer conveyance direction.

The cap member 25d is a supported portion provided at an end portion of the developer conveyance member 25 and supported by the developer frame body 14. A first bearing portion 14b and a second bearing portion 14c are provided at both longitudinal ends of the development frame body 14. The first bearing portion 14b is fit-engaged with the cap member 25d. The second bearing portion 14c is fit-engaged with the development conveyance gear 32. As a result, the developer conveyance member 25 is rotatably supported by the development frame body 14.

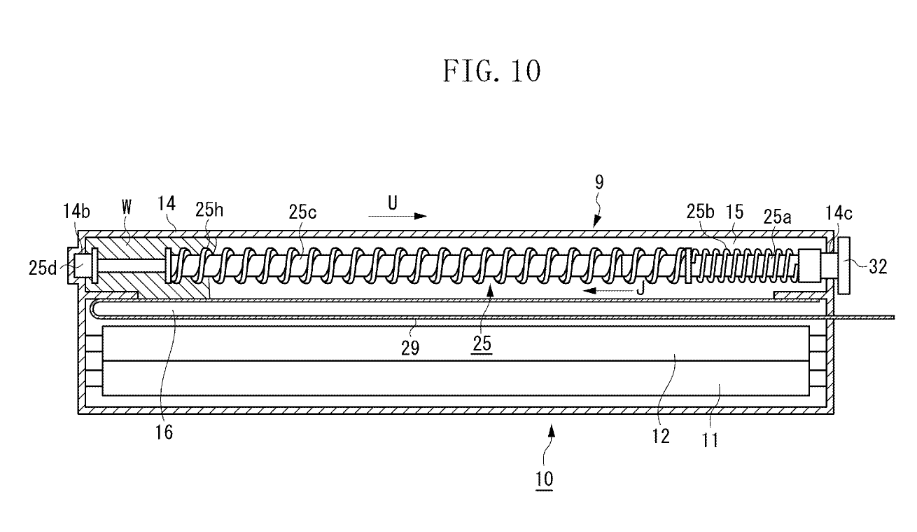

Next, the drive configuration of the developer conveyance member will be described with reference to FIGS. 1 and 10. FIG. 1 is a sectional view illustrating the construction of the developer conveyance member. FIG. 10 is a sectional view illustrating the drive construction of the developer conveyance member in the state in which the developer in the developer storage portion has been coagulated.

The conveyance portion 25c of the developer conveyance member 25 is characterized in that it is movable in the axial direction of the support shaft 25a. Specifically, when conveying developer, it is arranged at a predetermined first position, whereas, when the requisite torque for driving the developer conveyance member 25 exceeds a predetermined magnitude, it moves to a second position situated on the upstream side of the first position in the developer conveyance direction J.

It is when the density of the developer stored in the developer storage portion 15 increases that the driving torque of the developer conveyance member 25 exceeds the predetermined magnitude. This will be described in detail below.

First, the first position will be described. Normally, as illustrated in FIG. 1, the conveyance portion 25c of the developer conveyance member 25 conveys developer in the direction of the arrow J while being urged toward the cap member 25d by the urging member 25b.

Next, to be described will be how the developer conveyance member 25 is moved to the second position, which is on the upstream side of the first position in the developer conveyance direction J. As illustrated in FIG. 10, the developer W in the developer storage portion 15 may be gathered on the downstream side in the conveyance direction (the direction of the arrow J) of the developer conveyance member 25. This occurs when, during its transportation, the process cartridge P assumes an orientation in which its longitudinal direction is parallel to the vertical direction and in which the downstream side in the conveyance direction (the direction of the arrow J) of the developer conveyance member 25 is directed downwards.

At this time, the developer W is compacted and coagulated due to the vibration during the transportation, so that it exhibits high density. When, in this state, the developing unit 10 is driven, and the conveyance portion 25c of the developer conveyance member 25 rotates, the conveyance fin 25h of the conveyance portion 25c receives a force (reaction force) in the direction of the arrow U from the coagulated developer W. When the reaction force the conveyance portion 25c receives from the coagulated developer W exceeds the urging force due to the urging member 25b, the conveyance portion 25c moves to the upstream side in the developer conveyance direction J (the direction of the arrow U).

Specifically, when the conveyance portion 25c receives a force of a magnitude larger than a predetermined level from the developer as it rotates, the conveyance portion 25c moves from the first position (See FIG. 1), which is the position where the developer is conveyed, to the second position (See FIG. 10) which is situated on the upstream side of the first position in the developer conveyance direction J. The second position is a position where the reaction force in the direction of the arrow U the conveyance portion 25c receives from the developer and the urging force the conveyance portion 25c receives from the urging member 25b are balanced.

When the conveyance portion 25c moves to the second position, the conveyance portion 25c is spaced away from the developer gathered and coagulated on the downstream side in the developer conveyance direction J. As a result, the driving torque of the developer conveyance member 25 is reduced.

When the developing unit 10 is further continued to be driven, the sealing member 29 is removed from the development opening 28 by the take-up member 38. At this time, the development opening 28 is unsealed from the downstream side toward the upstream side in the developer conveyance direction J. When the sealing member 29 starts to be removed, the coagulated developer W in the developer storage portion 15 moves from the development opening 28 to the development portion 16, so that the reaction force in the direction of the arrow U in which the conveyance fin 25h receives from the developer is reduced. When this reaction force is reduced to a level lower than the urging force owing to the urging member 25b, the conveyance portion 25c moves in the direction of the arrow J due to the urging force of the urging member 25b as illustrated in FIG. 1, and returns to the first position (See FIG. 1) from the second position. As a result, it is possible to the conveyance portion 25c to convey the developer W in the direction of the arrow J. Thus, the coagulation of the developer W in the developer storage portion 15 is further eliminated.

In the present exemplary embodiment, the development opening 28 is unsealed from the downstream side in the developer conveyance direction J, so that the developer which has been coagulated on the downstream side of the developer storage portion 15 in the developer conveyance direction J can move to the development portion 16 at an early stage.

To summarize the above description, according to the above construction, the conveyance portion 25c of the developer conveyance member 25 moves from the first position, where the developer is conveyed, to the upstream side in the developer conveyance direction (second position) depending on the density of the developer in the developer storage portion 15. As a result, even in the state in which the developer in the developer storage portion 15 has been coagulated, it is possible to suppress, with a simple configuration, an increase in the driving torque of the developer conveyance member 15 in the early stage of use of the process cartridge. Further, in the present exemplary embodiment, it is the urging member 25b arranged in the developer storage portion 15 and the developer that moves the conveyance portion 25c to the first position and the second position. Thus, as compared with the configuration in which a clutch or the like for stopping the driving of the developer conveyance member 25 is provided outside the developer storage portion, it is possible to achieve a reduction in the size of the developer conveyance apparatus.

Although the present exemplary embodiment described by way of example is applied to the developer conveyance unit provided in the developing unit of the process cartridge, this should not be construed restrictively. For example, the present invention is naturally also applicable to the developer conveyance unit and the developer replenishment cartridge of an image forming apparatus not employing the process cartridge system.

While the present disclosure has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-249919 filed Nov. 15, 2011, which is hereby incorporated by reference herein in its entirety.

What is claimed is:

1. A developer conveyance apparatus for use in an image forming apparatus comprising:
a developer storage portion storing developer;
an opening for supplying developer from an interior to an exterior of the developer storage portion;
a sealing member configured to seal the opening;
a removing member configured to remove the sealing member from the opening; and
a conveyance portion arranged inside the developer storage portion and configured to convey the developer in a predetermined developer conveyance direction by rotating the conveyance portion,
wherein the conveyance portion can move between a first position and a second position on the upstream side with respect to the first position in the developer conveyance direction, and
wherein when the conveyance portion receives a force greater than or equal to a predetermined magnitude from the developer with the conveyance portion rotating while the removing member is removing the sealing member from the opening, the conveyance portion moves from the first position to the second position.

2. The developer conveyance apparatus according to claim 1, further comprising an urging member configured to urge the conveyance portion from the second position toward the first position.

3. The developer conveyance apparatus according to claim 2, wherein the urging member is a coil spring configured to rotate together with the conveyance portion and to convey the developer in the developer conveyance direction.

4. The developer conveyance apparatus according to claim 1, wherein after the conveyance portion has moved from the first position to the second position, the developer stored in the developer storage portion is supplied to the exterior of the developer storage portion via the opening, whereby the conveyance portion returns from the second position to the first position.

5. The developer conveyance apparatus according to claim 1, wherein when the removing member removes the sealing member from the opening, the opening is unsealed from the downstream side toward the upstream side in the developer conveyance direction.

6. A developing apparatus for use in an image forming apparatus comprising:
a developer storage portion storing developer;
an opening for supplying developer from an interior to an exterior of the developer storage portion;
a developer bearing member configured to bear the developer supplied from the developer storage portion;
a sealing member configured to seal the opening;
a removing member configured to remove the sealing member from the opening; and
a conveyance portion arranged inside the developer storage portion and configured to convey the developer in a predetermined developer conveyance direction by rotating to conveyance portion,
wherein the conveyance portion can move between a first position and a second position on the upstream side with respect to the first position in the developer conveyance direction, and
wherein when the conveyance portion receives a force greater than or equal to a predetermined magnitude from the developer with the conveyance portion rotating while the removing member is removing the sealing member from the opening, the conveyance portion moves from the first position to the second position.

7. The developing apparatus according to claim 6, further comprising an urging member configured to urge the conveyance portion from the second position toward the first position.

8. The developing apparatus according to claim 7, wherein the urging member is a coil spring configured to rotate together with the conveyance portion and to convey the developer in the developer conveyance direction.

9. The developing apparatus according to claim 6, wherein after the conveyance portion has moved from the first position to the second position, the developer stored in the developer storage portion is supplied to the exterior of the developer storage portion via the opening, whereby the conveyance portion returns from the second position to the first position.

10. The developing apparatus according to claim 6, wherein when the removing member removes the sealing member from the opening, the opening is unsealed from the downstream side toward the upstream side in the developer conveyance direction.

11. A process cartridge detachably attached to an apparatus main body of an image forming apparatus, comprising:
an image bearing member;
a developer storage portion storing developer;
an opening for supplying developer from an interior to an exterior of the developer storage portion;
a developer bearing member configured to bear the developer supplied from the developer storage portion;
a sealing member configured to seal the opening;
a removing member configured to remove the sealing member from the opening; and
a conveyance portion arranged inside the developer storage portion and configured to convey the developer in a predetermined developer conveyance direction by rotating the conveyance portion,
wherein the conveyance portion can move between a first position and a second position on the upstream side with respect to the first position in the developer conveyance direction, and
wherein when the conveyance portion receives a force greater than or equal to a predetermined magnitude from the developer with the conveyance portion rotating while the removing member is removing the sealing member from the opening, the conveyance portion moves from the first position to the second position.

12. The process cartridge according to claim 11, further comprising an urging member configured to urge the conveyance portion from the second position toward the first position.

13. The process cartridge according to claim 12, wherein the urging member is a coil spring configured to rotate together with the conveyance portion and to convey the developer in the developer conveyance direction.

14. The process cartridge according to claim 11, wherein after the conveyance portion has moved from the first position to the second position, the developer stored in the developer storage portion is supplied to the exterior of the developer storage portion via the opening, whereby the conveyance portion returns from the second position to the first position.

15. The process cartridge according to claim 11, wherein when the removing member removes the sealing member from the opening, the opening is unsealed from the downstream side toward the upstream side in the developer conveyance direction.
